(19) United States
(12) Patent Application Publication
(10) Pub. No.: US 2013/0266811 A1
(43) Pub. Date: Oct. 10, 2013

(54) COMPOSITIONS FOR PRODUCTION OF ABHESIVE COATINGS

(71) Applicants: Rudolf Hinterwaldner, Kirschseeon (DE); Stephan Hinterwaldner, Kirschseeon (DE)

(72) Inventors: Rudolf Hinterwaldner, Kirschseeon (DE); Stephan Hinterwaldner, Kirschseeon (DE)

(73) Assignee: HINTERWALDNER CONSULTING & PARTNER, Kirschseeon (DE)

(21) Appl. No.: 13/880,343

(22) PCT Filed: Oct. 14, 2011
(86) PCT No.: PCT/EP2011/067970

§ 371 Date: Jun. 25, 2013

(30) Foreign Application Priority Data
Oct. 19, 2010 (EP) 10188045.8

(51) Int. Cl. C09J 167/07; C09J 7/02; C09J 163/00; C09J 133/08; C09J 133/14; C09J 143/04

(52) U.S. Cl. CPC C09J 167/07; C09J 133/14; C09J 143/04; C09J 163/00; C09J 133/08; C09J 7/0228
USPC 428/413; 524/558; 524/547; 523/400; 524/556; 522/183; 522/99; 522/170; 522/107; 427/385.5; 428/446; 428/522

(57) ABSTRACT

The present invention relates to compositions which comprise an olefinic component and a compound reactive or curable with the olefinic component, and which are suitable for production of release layers

The present invention relates to compositions which are suitable for the production of abhesive coatings.

Abhesive coatings play a significant part in industry. The aim here is to equip surfaces such that adhesive materials do not attach firmly and can be removed without residue. Abhesive coatings have acquired particular significance especially as release coatings for release substrates in the production of adhesive sheets and adhesive tape.

Described in the prior art of the abhesive equipping of surfaces are a multiplicity of substances which meet the desired functions to different degrees. Nowadays, surfaces are abhesively equipped using, largely, silicone release agents based on polyorganosiloxanes (silicones). Since silicones, however, are more expensive, by a multiple, than conventional abhesive substances, such as paraffin, wax, and metal soaps, they cannot always be used, for reasons of economics, in the amounts needed in order to achieve the required abhesion. As a consequence of this there has been no lack of efforts to lower the costs associated with equipping surfaces abhesively, by means of better economic solutions. These efforts, however, have not led to satisfactory results, for reasons including the fact of a lack of silicone materials which allow more rapid curing, in order to increase the web speeds during coating. Another problem not yet solved satisfactorily are low graduated release values for silicone coatings, since when surfaces are equipped with silicone materials, these values can be reduced only when the reactivity is higher. A decisive part is played here by the relatively high curing and/or crosslinking temperatures and also by the web speeds. At low curing and crosslinking temperatures, the substrate moisture content can be regulated more optimally in the case of cellulose-based substrates. Low temperatures are also needed in the context of the equipping of thermoplastic substrates, for curing and/or crosslinking. These and other disadvantages exist with commercially customary products.

In the free-radical polymerizing, curing and/or crosslinking of unsaturated compounds, such as polyester resins, acrylic resins, and methacrylic resins, the reactions on the surfaces are inhibited by molecular atmospheric oxygen. This atmospheric oxygen makes the radicals ineffective, thereby preventing the curing reaction and causing the surface to remain tacky. Attempts have been made to protect the surface from atmospheric oxygen by lining it with foil, film, glass plates, and the like. Since, however, this is much too laborious for practical use, the addition of paraffin has been proposed (DE-C 9 48 818). In the course of the curing, the paraffin floats to the surface, where it forms a protective layer with respect to the atmospheric oxygen. The addition of paraffin gives rise to problems, however—for example, the problem that paraffin crystallizes out in the curable compositions at low temperatures and does not float at high temperatures. Likewise explained by the properties of paraffin is the fact that paraffin-containing compositions cannot be cured at excessively high temperatures. Hence with paraffin-containing curable compositions it is not possible to achieve short reaction times at elevated temperature, since heating can be carried out only when the paraffin has totally floated. The industry has been waiting for a long time already for improved solutions.

US 2011/0189422 (corresponding to WO 2009/083563) describes a method for producing an anti-adhesive silicone coating, this coating being obtained by coating a substrate with an at least partly crosslinked silicone oil and then carrying out treatment with a cold plasma. In this way it is possible to modify the adhesion properties of the coating.

US 2006/0235156 describes a method for producing a thermoplastic vulcanizate by mixing a thermoplastic first polymer, an elastomeric second polymer, a carboxylic anhydride, a radical initiator, and a tackifying compound, and reacting the mixture with a silane, to give a nontacky thermoplastic vulcanizate. The vulcanizate can be used in particular as a sealant in the production of insulating glass.

EP 373 941 A2 describes polymethylsilsesquioxane particles which have been surface-modified by treatment with an organotrialkoxysilane. Through the surface modification it is possible to introduce organic groups, such as a vinyl group or a 3,3,3-trifluoropropyl group. Particles with a vinyl group are suitable for the production of high-strength rubber materials, and particles with a 3,3,3-trifluoropropyl group are suitable for improving the release properties.

DE 10 2009 008 257 A1 (corresponding to WO 2010/091825) describes copolymer waxes preparable by reacting α-olefins having at least 28 carbon atoms with unsaturated polycarboxylic acids or anhydrides thereof in the presence of a radical initiator. The copolymer waxes are used as lubricants or release agents in chlorine-containing thermoplastics, such as polyvinyl chloride.

WO 2011/054434 describes release films with enhanced release effect, the release films comprising at least one substrate which is based on a thermoplastic polymer and which on at least one surface is equipped with a lipophilic compound that has an embossed structure. Lipophilic compounds suitable are fatty acids, fatty alcohols, long-chain amines, fatty acid esters, fatty amides, and surfactants.

The object on which the present invention is based is that of providing compositions which allow cost-effective production of release coatings having good release properties.

It has now been found that, surprisingly, this object is achieved through the use of compounds of the formulae I and II as indicated below.

The present invention accordingly provides compositions comprising
a) at least one compound of the formula I or II

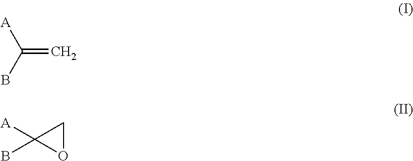

in which A and B, which may be identical or different, stand for a branched or unbranched alkyl group having 3 to 130 carbon atoms, but at least one of the radicals A and B stands for a branched or unbranched alkyl group having at least 6 carbon atoms, and
b) at least one compound which is curable or reactive with a compound of the formula (I) or (II).

According to one embodiment the radicals A and B together have at least 12 carbon atoms.

According to another embodiment at least one of the radicals A and B stands for a branched or unbranched alkyl group having 4 to 40 carbon atoms and more particularly for a straight-chain or branched alkyl group having 6 to 24 carbon atoms. According to a further embodiment A and B each stand for a branched or unbranched alkyl group having 6 to 24 carbon atoms.

According to another embodiment A and B are different.

According to another embodiment A stands for an unbranched alkyl group having 8 to 12, more particularly 10, carbon atoms and B stands for an unbranched alkyl group having 6 to 10, more particularly 8, carbon atoms.

The compounds of the formulae I and II are known, available commercially and/or preparable by methods known to the skilled person, as for example in accordance with the methods described in EP 5 133 380 A1, EP 1 849 757 A1, EP 1 852 408 A1, and EP 1 908 746 A1. The compounds of the formula II are prepared usefully by epoxidizing the compounds of the formula I customarily, as for example by oxidation with peracids, such as perbenzoic acid, hydrogen peroxide, tert-butyl hydroperoxide, etc.—see, for example, Houben-Weyl, volume V 1/3, 1965.

The compounds of the formulae I and II possess high reactivity, low volatility, high thermal stability, low viscosity, and are liquid at room temperature.

The following are suitable as component (b):

A) organosilicon compounds which are reactive with a compound of the formula I or II. Organosilicon compounds of this kind are silanes (organosilicon compounds which still contain hydrogen atoms on the silicon atoms), which are able to enter into addition reactions with the compounds of the formula I or II. Further suitable organosilicon compounds are those which are able to react by a radical mechanism, initiated for example by radical-forming initiators, such as peroxides, or irradiation, and also organosilicon compounds which are able to react by a radical/ion mechanism and those which are able to enter into noble metal-catalyzed reactions. Suitable, furthermore, are organosilicon compounds which are able to enter into condensation reactions or condensation-crosslinking reactions.

Suitable components (b) are therefore unbranched, branched and/or cyclic silanes, silanols, polysilanes, polyorganosiloxanes, polysilazanes, polysilthianes, polysilalkenyls, polysilarylenes, polysilalkenesiloxanes, polysilarylenesiloxanes, polysilalkylenesilanes, polysilarylenesilanes having in each case at least one silicon group and/or organo-functional group. These groups are preferably as follows:

SiH, Si—OH, Si-halogen, Si—SH, —CH═CH₂ or —O—CO—CR═CH₂, where R stands for H or methyl.

Epoxy-containing organosilicon compounds which cure under UV irradiation by a cationic curing mechanism are described for example in U.S. Pat. No. 4,421,904; U.S. Pat. No. 4,547,431; U.S. Pat. No. 4,952,657; U.S. Pat. No. 5,217,805; U.S. Pat. No. 5,279,860; U.S. Pat. No. 5,340,898; U.S. Pat. No. 5,360,833; U.S. Pat. No. 5,650,453; U.S. Pat. No. 5,866,261, and U.S. Pat. No. 9,573,020.

Organosilicon compounds which cure by a free radical polymerization mechanism by irradiation with UV light or electron beams are described for example in U.S. Pat. No. 4,201,808; U.S. Pat. No. 4,568,566; U.S. Pat. No. 4,678,846; U.S. Pat. No. 5,494,979; U.S. Pat. No. 5,510,190; U.S. Pat. No. 5,552,506; U.S. Pat. No. 5,804,301; U.S. Pat. No. 5,891,530; U.S. Pat. No. 5,977,282; U.S. Pat. No. 6,211,322; U.S. Pat. No. 4,301,268, and U.S. Pat. No. 4,306,050.

Useful embodiments of these organosilicon compounds are the following:
A1) epoxysilicones which are obtained by reacting a silane or siloxane having SiH groups with an olefinic epoxide, in the presence of a tertiary amine and of a hydrosilylation catalyst (rhodium or platinum metal complex). As the olefinic epoxide it is possible more particularly to use limonene oxide, 4-vinylcyclohexene oxide, allyl glycidyl ether, glycidyl acrylate, 7-epoxy-1-octene, vinylnorbornene monoxide, and dicyclopentyldiene monoxide.
   Further epoxysilicones are described in U.S. Pat. No. 5,217,805; U.S. Pat. No. 4,421,904; and U.S. Pat. No. 4,547,431, the disclosure content of which is hereby incorporated in full by reference.
A2) SiH-functional organosilicon compounds, examples being those of the formula

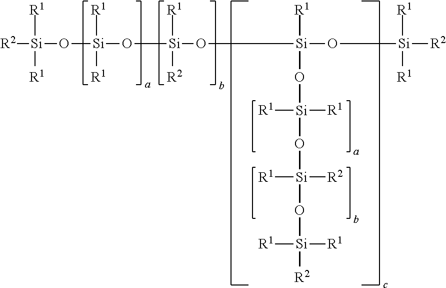

in which R¹ stands for identical or different aliphatic or aromatic hydrocarbon radicals having 1 to 20 carbon atoms, more particularly for methyl; R² stands for R¹ or H, and at least three of the radicals R² stand for H; a stands for 5 to 500, more particularly 10 to 100; b stands for 1 to 50, more particularly 1 to 20; c stands for 0 to 5, more particularly for 0.
Polysiloxanes of this kind are described in DE 10 2005 001 040, the disclosure content of which is hereby incorporated in full by reference.
Suitable silanes or siloxanes are also those of the general formula

R²₃SiO(R³₂SiO)nSiOR²₃
in which R² and R³ independently of one another stand for H or C₁-C₄ alkyl, more particularly methyl, and at least two of the radicals R² or R³ stand for H, and n stands for 1 to 1000, more particularly 4 to 400. These epoxysilicones are described in EP 578354 A2, the disclosure content of which is hereby incorporated in full by reference.
A3) Alkenyloxy-functional organosilicon compounds, examples being those of the formula

Rₐ(R¹O)_{b}Y_{c}SiO_{d}
in which a stands for 0, 1, 2 or 3; b stands for 1, 2 or 3; c stands for 0 or 1, and the sum a+b+c stands for a number ≧1 to ≦4;
d stands for 4−(a+b+c+)/2; R, which may be identical or different, stands for C₁-C₄-alkyl, more particularly methyl; R¹, which may be identical or different, stands for C₁-C₄ alkyl, more particularly methyl; Y stands for a radical of the formula —(CH₂)₂—R²—(A-R³)₂—O—CH═CH—CH—R⁴; A stands for —O—, —S—, —COO— or —OCO—; R² stands for C₁-C₆-alkylene or C₅-C₇-cycloalkylene; R³ stands for C₂-C₄ alkylene and R⁴ stands for H or C₁-C₄ alkyl and z stands for 0, 1 or 2. The molecular weight of these compounds is situated in general in the range from 200 to 100 000, more particularly 230 to 30 000.
These compounds are described in EP 396130 A2, the disclosure content of which is hereby incorporated in full by reference.
Further vinyloxy-functional organopolysiloxanes are described in WO 83/03418, the disclosure content of which is hereby incorporated in full by reference.
A4) Acrylate- or methacrylate-functionalized polysiloxanes having at least one acrylate or methacrylate group. These are more particularly organopolysiloxanes of the following formulae:

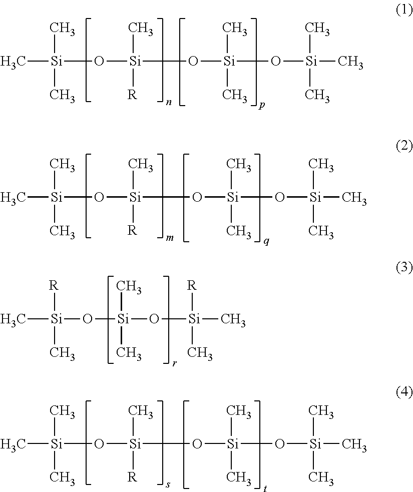

In these formulae R stands for CH₂═CH(R¹)—COO—(X)ₓ—Y—; n stands for 5 to 15; p stands for 50 to 150; x stands for 0 or 1 to 100; X stands for —CH₂CH₂O—, —CH₂—CH(OH) —CH₂—, —CH₂—CH(CH₃)—O—; Y stands for C₁-C₄-alkylene. Preferably x stands for 0 or 1, X stands for —CH₂—CH(OH)—CH₂—O— and Y stands for —(CH₂)₃; m stands for 1 to 10; q stands for 151 to 300; r stands for 20 to 500; s stands for 1 to 10; and t stands for 301 to 1000.

These organopolysiloxanes may also take the form of a mixture, comprising more particularly 50 to 99.9 parts by weight of the organopolysiloxane of the formula (1), 0 to 50 parts by weight of the organopolysiloxane of the formula (2) and/or of the formula (3), and 0 to 10 parts by weight of the organopolysiloxane of the formula (3), with the fractions of the components adding up to 100 parts by weight.

These polyorganosiloxanes are described in U.S. Pat. No. 6,548,568, the disclosure content of which is hereby incorporated in full by reference.

Further acrylate- or methacrylate-functionalized polyorganopolysiloxanes are described in U.S. Pat. No. 6,211,322, the disclosure content of which is hereby incorporated in full by reference.

Further acrylate- or methacrylate-functionalized organopolysiloxanes correspond to the formula

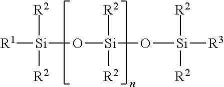

in which R¹ stands for CH₂═C(R⁴)COO—X—; X stands for a bond or C₁-C₄-alkylene; R² stands for C₁-C₄-alkyl, more particularly for methyl; R³ stands for R¹ or R²; R⁴ stands for H or methyl; and n stands for 1 to 300, more particularly 5 to 100.
A5) Further suitable organosilicon compounds are those of the formula

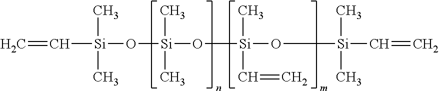

in which n stands for 90 to 5000, m stands for 0 to 4, and n/n+m is 0.96-1.0.

The organosilicon compounds suitable for the release coating generally possess viscosities of 150 mPa·s to 2 000 mPa·s (dynamic). In practice, silicone polymers having viscosity values of 150-900 mPa·s are preferred, more particularly those which can be processed solventlessly.

### B) Unsaturated Polyester Resins

Unsaturated polyester resins are formed by polycondensation of unsaturated dicarboxylic acids with diols. They can be cured by free-radical polymerization or by radiation. Examples of suitable unsaturated dicarboxylic acids include maleic acid, maleic anhydride or fumaric acid. The unsaturated dicarboxylic acid is usefully replaced in part by a saturated dicarboxylic acid, such as o-phthalic acid, terephthalic acid, tetrahydrophthalic acid, adipic acid or sebacic acid. Examples of suitable diols include alkanediols, such as ethylene glycol, 1,2-propanediol, 1,3-butanediol, neopentyl glycol, polyethylene glycols and polypropylene glycols, more particularly those having a molecular weight of up to 2000, such as diethylene glycol, triethylene glycol, tetraethylene glycol, dipropylene glycol, tripropylene glycol or tetrapropylene glycol, bisphenols, such as bisphenol A, and ethoxylated or propoxylated bisphenols. The unsaturated polyester resins may also be employed in combination with styrene as reactive diluent. Preparation and construction of unsaturated polyester resins are described for example in Kunststoffhandbuch vol. 10, 1988, pages 94ff. This publication is hereby

incorporated in full by reference.

### C) Acrylate- or Methacrylate-Functionalized or Allyl-Functionalized Polyalkylenediols

Acrylate- or methacrylate-functionalized polyalkylenediols are obtained by esterifying a polyalkylenediol with acrylic acid or methacrylic acid, allyl-functionalized polyalkylenediols by etherifying a polyalkylenediol with allyl alcohol. As polyalkylenediol use is made, for example, of polyethylene glycols, polypropylene glycols or copolymers thereof, more particularly those having a molecular weight of 1000 to 20000.

### D) Acrylic or Methacrylic Esters

Suitable acrylic or methacrylic esters are esters of acrylic or methacrylic acid with C₁-C₁₈ alkanols, more particularly C₁-C₁₂ alkanols, such as methyl acrylate, methyl methacrylate, ethyl acrylate, ethyl methacrylate, n-butyl acrylate, 2-ethylhexyl acrylate, etc.

E) Compounds which Enter into an Addition Reaction with the Compounds of the Formulae I or II

Organic compounds particularly suitable for polyaddition with a compound of the formula I or II are those which possess reactive hydrogen atoms. These include, among others, amides, amines, saturated and unsubstituted monobasic and polybasic carboxylic acids and their anhydrides, aldehydes and the like, and also isocyanates. In the case of the compounds according to formula I, the addition proceeds in accordance with Markovnikov's rule, or, in the case of the radical addition, under the influence of radiation or catalysts, such as peroxides, for example, it proceeds in opposition to this rule (anti-Markovnikov addition). In the case of the epoxidized compounds according to formula II, the addition takes place on the epoxide group.

The compounds of the formulae I and II above are not only able to influence the structure of the release layer, but instead serve simultaneously as a reactive diluent, which is incorporated chemically into the matrix in the course of curing and/or crosslinking.

As a result of this dual function it is possible in accordance with the invention to control the rheology and hence also the machine properties. After setting has taken place, the desired abhesive properties are obtained.

The weight ratio of component (a) to component (b) is typically in the range from 1:5 to 2:1, more particularly in the range from 1:3 to 1:1.

The compositions of the invention can be cured thermally at temperatures of in general in the range from about 0° C. to about 120° C., or by irradiation in the presence of initiators. The initiators may already be present in the compositions of the invention or may be added immediately prior to use. Suitable initiators for thermal curing are more particularly peroxides, such as benzoyl peroxide, hydrogen peroxide, or tert-butyl hydroperoxide. Suitable photoinitiators are known to the skilled person and described for example in U.S. Pat. No. 5,650,453; U.S. Pat. No. 5,217,805; U.S. Pat. No. 4,547,431; U.S. Pat. No. 4,576,999, and in other US patents specified above. The amount of initiator is generally in the range from 0.1% to 10% by weight, based on the total weight of the composition.

Additionally, the compositions of the invention may comprise customary auxiliaries and additives, such as adhesion promoters, curing accelerators, antioxidants, binders, dyes, pigments, and also solid particulate fillers.

The compositions of the invention have the advantage that they can be formulated solventlessly. The use of high fractions of toxicologically and environmentally objectionable solvents, such as white spirit, toluene, xylene, and chlorinated hydrocarbons, as necessary in the prior art, can therefore be avoided. There is also therefore no need for evaporation of the solvent, thereby rendering the costly removal of the solvent under suction superfluous and shortening the time cycle of the application. The desired viscosity of the composition can be set through the nature and amount of component (a), which is to be considered as a reactive diluent. Because component (a), with its high methylene group content per molecule, is incorporated into the crosslinked matrix, the hydrophobic and/or abhesive properties of the resulting product are significantly improved at the same time. The abhesive properties—measured as release force with respect to tacky materials—can therefore be set in a graduated way through the amount of component a). Because of the high fraction of nonpolar alkyl groups, it is possible for high fractions of component b), more particularly of the expensive organosilicon compounds, to be replaced, with the abhesive properties in spite of this being improved or at least maintained. Since no solvent is needed for the use of the compositions of the invention, they can also be crosslinked and/or cured at low temperatures, e.g., below 100° C. As a result of this, even heat-sensitive plastics webs can be equipped with the abhesive compositions of the invention that are obtained. Overall, therefore, the coating technology can be made more favorable as well, since the disposal problems are greatly reduced.

Especially suitable for producing a release agent layer are compositions which comprise, as component b), one or more organosilicon compounds A). For this purpose, the compositions of the invention are applied to sheetlike substrates, such as paper, polymeric films, textiles, metal foils, etc., and are subjected to curing. In order to obtain layer thicknesses of around 1 μm, corresponding approximately to coat weights of around 1 g/m², the release agent compositions are usefully applied using applicator means having 4 or 5 rolls. The necessary web speeds for equipping the surfaces of sheetlike substrates in industrial practice are
for thermal curing, up to 600 m/min;
for UV radiation crosslinking, up to 400 m/min;
for EBC beam curing, up to 1000 m/min;
   in a roll-to-roll operation. For thermal curing, temperatures in the range from 40° to 120° C. are generally sufficient. Crosslinking with UV light takes place more particularly at a wavelength of 200 to 400 nm. EBC beam curing requires a radiation dose of 5 kGy-50 kGy.

Curing is accomplished usefully by irradiation with UV light, more particularly with a wavelength of 200 to 400 nm. The required irradiation time is short and is situated in the range from seconds through to a number of minutes. For thermal curing, temperatures in the range from 40 to 90° C. are generally sufficient.

Compositions of the invention which comprise, as component b), a compound B) to D) can be used more particularly as hydrophobizing agents and release agents in numerous areas of industry, as for example as a lubricant additive in thread adhesives, and for hydrophobizing inorganic or organic surfaces of various materials and articles thereof.

In the case of thread bonding, the pre-tension that is achievable is determined inter alia only by the friction coefficient (surface-dependent) and by the material of the screw or thread. Known lubricant additives, such as polyethylene wax powders, are suitable on the one hand for meeting the friction coefficients required by the industry in an assembly context. On the other hand, however, they possess the disadvantage that they may pass, migrate or the like in a layer of adhesive, thereby, over time, adversely affecting or blocking the securement of bonding and sealing, and increasing the prevailing torque or breakaway moment of the bonding and sealing securement. As has now surprisingly been found, the compositions of the invention decisively enhance the friction coefficients and also “preserve” them during storage and during stress at pretensioning and the like. Moreover, they lower the prevailing torque or breakaway moment of the bonding and sealing securement.

The compositions of the invention can also be microencapsulated. Such microcapsules possess sizes of 10 to 300 μm. In this form, they can also be added to preliminary thread coatings. Generally speaking, the amount added is 0.1%-10% by weight, more particularly 0.1-5% by weight, preferably 0.5-3% by weight, based on 100 parts by weight of preliminary coating composition.

As mold release agents, the compositions may be added as an additive to a thermoplastic composition. On curing and/or crosslinking, the agent is incorporated chemically into the matrix, and hence is no longer able to migrate. The abhesive and lubricity properties are retained. In this case, among others, economic advantages are offered in connection with the production of injection moldings from plastics, and other, reinforced or nonreinforced, plastics articles.

In the case of the production of self-adhesive articles, the compositions of the invention can be added even to the as yet uncured adhesives or binders. In this way, after curing, it is possible to produce end products having controlled release properties—that is, it is possible, for example, to produce weakly to strongly bonding (adhesive) layers in a controlled way. The greater the amount of composition of the invention that is added, the lower the tack becomes.

In the case of the free-radical and radiation-chemical curing and crosslinking of the compositions of the invention which comprise unsaturated polyester resins, acrylic compounds, methacrylic compounds, and allyl compounds, an inert protective layer with respect to oxygen-containing atmospheres is produced. As a result, oxygen inhibition of curing is prevented, and tack-free surfaces are formed. The amounts of component a) added may in this case be below 10%—based on the amount of component b). As protectants, they are integrated simultaneously into the plastics matrix. The inhibition of curing is of interest particularly for radiation-curable products, since as a result it is possible when curing to do without an inert gas atmosphere and/or the addition of synergists.

A further particular form of application of the present invention is the production of self-supporting films and sheets having specific hydrophobic and/or abhesive properties from the molding compositions obtained in accordance with the invention. They can be used to produce hydrophobic and/or dirt-repellent sheets for construction, abhesive release films for the lining and packaging of sticky compositions and substrates, such as pressure-sensitive adhesives, adhesive films, and adhesive tapes, which exhibit improved release properties and are more economical and more eco-friendly, because the adhesive compositions do not attach to their surfaces.

The compositions of the invention can also be suitably used for the impregnation and hydrophobizing of natural substances, such as cellulosic fibers, wood chips and the like. Hence it is also possible, as has surprisingly been found, for the wood chips for chipboard manufacture to be hydrophobized. This, in contrast, is not a function fulfilled by the saturated isoparaffins used according to the prior art (see Adhäsion, issue 4/1983). It can therefore be assumed that the compositions of the invention have taken part in the setting reactions of the polycondensation or polyaddition glues.

The examples which follow illustrate the invention without limiting it.

### EXAMPLES

The quantity figures and quantitative ratios used in the examples relate in general to weight (parts by weight=pbw)

### Product of Formula I:

2-octyl-1-dodecene
density (g/cm³): 0.800
viscosity (40° C.): 4.5 mm²/sec (kinematic)
flash point: 186° C.
double bond: 1

### Product of Formula II:

2-decyl-2-octyloxirane
density (g/cm³): 0.840
viscosity: (20° C.): 8.6 mPa·s (dynamic)
epoxy group: 1

### Examples 1 and 2

The following free-radically curing coating compositions were produced:

| | Example | Example | |
|---|---|---|---|
| | 1 | 2 | Comparative |
| Bisphenol A dimethacrylate | 70 | 70 | 70 |
| Product of formula 1 | 30 | 5 | — |
| Methyl methacrylate (diluent) | — | 25 | 30 |
| N.N-Diethylanilines | 1 | 1 | 1 |
| Benzoyl peroxide, 50% in | 4 | 4 | 4 |
| plasticizer | | | |

After the benzoyl peroxide reaction initiator had been mixed in, the 3 coating compositions were used to coat sandblasted steel panels in a film thickness of around 100 μm. After about 10 to 12 minutes, all 3 coating compositions gelled. While the coating compositions of examples 1 and 2 did not have a tacky surface, and were sandable, the surface formed from the comparative coating composition was tacky and greasy.

### Examples 3 and 4

The following addition-crosslinking release agents were produced, and used to implement release coatings on sheetlike carrier material.

| | Example | Example | |
|---|---|---|---|
| | 3 | 4 | Comparative |
| Polydimethylsiloxane with vinyl | 75 | 60 | 100 |
| groups; viscosity: 500 m Pa · s, | | | |
| Product of formula I | 25 | 40 | — |
| Siloxane hydrogen crossslinker | 4.8 | 4.8 | 4.8 |
| (see example 7) | | | |
| Catalyst (hexachloroplatinic(IV) | 6.7 | 6.7 | 6.7 |
| acid) | | | |
| Viscosity/20° C., mPa · s | 350 | 280 | 500 |
| Substrate: satinized paper 67 g/m² | | | |
| Coat weight g/m² | 2-3 | 2-3 | 2-3 |
| Curing time 100° C. sec | 30 | 30 | 40 |
| Curing time 120° C. sec | 9 | 9 | 15 |
| Release force to FINAT 10 mN/cm | 95 | 90 | 93 |
| Residual tack to FINAT 11% | 98 | 95 | 95 |

FINAT test methods: http://www.adhesivetest.com/resources/docs/FinatTestMethods.pdf

Average values from 5 measurements

### Example 5

100 pbw of 2-decyl-2-octyloxirane (formula II) were reacted with 30 pbw of acrylic acid. 3 mol of this reaction product were mixed with 1 mol of pentaerythritol triacrylate and the mixture was coated out onto a steel panel and cured by irradiation with an electron beam dose of 30 KGy without an inert gas atmosphere. The irradiated product (filler) had good through-volume curing, and its surface was not tacky.

### Example 6

A filling composition comprising a highly reactive, unsaturated polyester resin—Derakane Momentum® type 470-300 (viscosity about 350 mPa·s, styrene content about 30%)—was produced, and 3% by weight of 2-octyl-1-dodecene (formula I) were added. For comparison, 5% by weight of paraffin were added instead of 2-octyl-1-dodecene (formula I). Following addition of 5% benzoyl peroxide, 50% in plasticizer, this composition cured at room temperature within 10 minutes. While the composition with the inventive addition of 2-octyl-1-dodecene was tack-free on the surface, the surface was still slightly tacky in the case of the addition of paraffin.

### Example 7

100 pbw of a silicone acrylate were mixed homogeneously with 40 pbw of 2-octyl-1-dodecene. This mixture was then divided and used to produce radiation-chemical and photochemical curing and/or crosslinking systems. The photochemically curable composition was admixed homogeneously with 5% by weight of diethoxyacetophenone, 2% by weight of benzophenone, and 2% by weight of an amine synergist. These two mixtures were used to coat the substrates below, which were then cured and/or crosslinked.

| | Coating | | UV lamp |
|---|---|---|---|
| | thickness | EBC dose | 80 W/cm |
| Substrates | μm | KGy | seconds |
| Paper, 67 g/m2 | 2 | 30 | 5 |
| Plasticized PVC film, | 1 | 25 | — |
| 100 μm | | | |
| OPP film, 100 μm | 1 | 12 | — |
| Steel panel, | 30 | 50 | 17 |
| sandblasted | | | |

The silicone acrylate is a hexafunctional silicone compound of the formula:

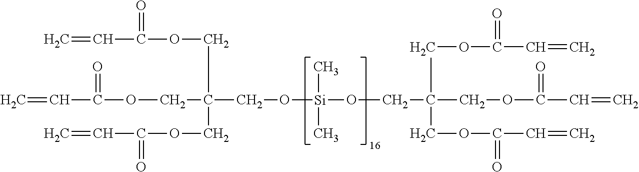

and additionally contains 10% of a siloxane hydrogen crosslinker of the formula

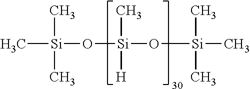

### Examples 8 and 9

The following addition-crosslinking silicone release agents were produced and used to produce coatings on satinized paper (67 g/m²).

| | Example | Example | |
|---|---|---|---|
| | 8 | 9 | Comparative |
| Polydimethylsiloxane with vinyl | 50 | 70 | 100 |
| groups Viscosity: 500 m Pa · s, | | | |
| 2-Octyl-1-dodecene | 50 | 30 | — |
| Siloxane hydrogen crosslinker | 4 | 4 | 4 |
| (see example 7) | | | |
| Catalyst (hexachloroplatinic(IV) | 0.5 | 0.5 | 0.5 |
| acid) | | | |
| Viscosity/20° C./mPa · s | 250 | 300 | 500 |
| Substrate: satinized paper 67 g/cm² | | | |
| Coat weight g/cm² | 2-3 | 2-3 | 2-3 |
| Curing time 100° C. sec | 30 | 30 | 30 |
| Release force to FINAT 10 | 27 | 31 | 28 |
| Residual tack to FINAT 11% | 95 | 96.8 | 87.5 |

### Examples 10 and 11

Examples 8 and 9, following the addition of 5% by weight of diethoxyacetophenone, 2% by weight of benzophenone, and 2% by weight of an amine synergist—based on the total amount—and after the equipping of satinized paper surfaces (67 g/m²) at 2-3 g/m², were crosslinked with UV radiation (80 watts/cm) and subjected to a tape removal and bonding test. The results are summarized in table 1.

TABLE 1
UV-cured silicone release paper (paper weight 67 g/m²)

| | | | Test adhesive tapes | | | | | |
|---|---|---|---|---|---|---|---|---|
| | | | Testing Pressure Sensitive Tapes | | | | | |
| | | | TESAFILM 4970 | | TAPE P 69 | | | |
| | | | (Beiersdorf) | | (PERMACEL) | | Label adhesive | |
| Solventless | | Web speed | | Residual | Release Force | Residual | Release Force | Residual |
| silicone | Coat | per UV | Release Force | tack | FINAT No. | tack | FINAT No. | tack |
| release agent | weight | lamp 80 | FINAT No. | FINAT | 10 mN/cm | FINAT | 10 mN/cm | FINAT |
| Example No. | g/m² | watts/cm m/min. | 10 mN/cm | No. 11% | (g/inch) | No. 11% | (g/inch) | No. 11% |
| Comparative | 2-3 | 100 | 27 | 87 | 200 | 89 | 140 | 90 |
| 9 | 2-3 | 100 | 28 | 95 | 210 | 92.4 | 130 | 93 |
| 10 | 2-3 | 100 | 31 | 96.8 | 190 | 97.5 | 130 | 95 |

It can be seen that the use of the inventive coating materials results in superior properties for all of the parameters tested.

### Example 12

A preliminary thread coating material was prepared from microencapsulated acrylates and peroxides in a toluene-containing acrylate solution. Fillers, more particularly precipitated chalk, had been incorporated into these mixtures. This mixture was subsequently divided and one part was admixed with 5% by weight of microencapsulated 2-octyl-1-dodecene (15 μm). These mixtures were used to coat the threads of M10, 8.8 bolts. The toluene was subsequently evaporated off in 24 hours. 5 bolts each were then screwed together with the counterthread (nut) and left to stand at room temperature for 24 hours for curing. Table 2 summarizes the results (for the comparative, a commercially customary product was used).

TABLE 2
Test values with preliminary thread coating materials
Comparative test results from 5 individual tests
on M10, 8.8 bolts after 24 hours' curing

| | | Example | |
|---|---|---|---|
| | Comparative | 12 | Standard |
| Overtightening | 0.48 | 0.41 | DIN 54454 |
| moment/Nm | | | |
| Breakaway moment/Nm | 25.84 | 19.17 | DIN 54454 |
| Thread friction | 0.33 | 0.29 | VDI Directive 2230 |
| coefficient μ | | | |
| Prevailing torque/Nm | 20.95 | 5.78 | Din 54454 |

It can be seen that the use of the inventive coating materials results in superior properties for all of the parameters tested.

1. A composition comprising
a) at least one compound of the formula I or II 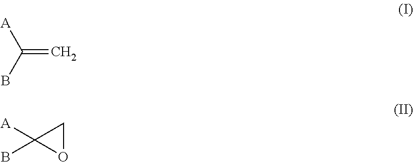
in which A and B, which may be identical or different, stand for or a branched or unbranched alkyl group having 3 to 130 carbon atoms, but at least one of the radicals A and B stands for a branched or unbranched alkyl group having at least 6 carbon atoms, and
b) at least one compound which is curable or reactive with a compound of the formula I or II and is selected from
A) organosilicon compounds,
B) unsaturated polyester resins,
C) acrylate, methacrylate- or allyl-functionalized polyalkylenediols,
D) acrylic or methacrylic esters, and
E) compounds which enter into an addition reaction with component a).

2. A composition as claimed in claim 1, wherein A and B together contain at least 12 carbon atoms.

3. A composition as claimed in claim 1, wherein A and B independently of one another stand for an alkyl group having 6 to 24 carbon atoms.

4. A composition as claimed in claim 1, wherein A and B are different.

5. A composition as claimed in claim 3, wherein A is an unbranched alkyl group having 10 carbon atoms and B is an unbranched alkyl group having 8 carbon atoms.

6. A composition as claimed in claim 1, wherein component b) is selected from organosilicon compounds, unsaturated polyester resins, acrylate- or methacrylate-functionalized or allyl-functionalized polyalkylenediols, and acrylic or methacrylic esters.

7. A composition as claimed in claim 6, wherein the organosilicon compound is radiation-curable.

8. A composition as claimed in claim 7, wherein the radiation-curable organosilicon compound is an organopolysiloxane containing epoxy groups, an SiH-functional organosilicon compound or an organopolysiloxane containing acryloyloxy or methacryloyloxy groups.

9. A composition as claimed in claim 8, wherein the silicone containing epoxy groups are obtained by reacting a silane or siloxane having SiH groups with an olefinic epoxide, in the presence of a tertiary amine and of a hydrosilylation catalyst.

10. A composition as claimed in claim 7, wherein the SiH-functional organosilicon compound is a compound of the formula
R²₃SiO(R³₂SiO)nSiOR²₃
in which R² and R³ independently of one another stand for H or C₁-C₄ alkyl, where at least two of the radicals R² or R³ stand for H, and n for 1 to 1000.

11. A composition as claimed in claim 8, wherein the polysiloxane containing acryloyloxy or methacryloyloxy groups is a compound of the formula 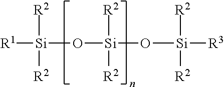
in which R¹ stands for CH₂═C(R⁴)—COO—X—; X stands for a bond or C₁-C₄ alkylene; R² stands for C₁-C₄ alkyl; R³ stands for R¹ or R²; R⁴ stands for H or methyl; and n stands for 1 to 300.

12. A composition as claimed in claim 1, wherein the weight ratio of component (a) to component (b) is in the range from 1:5 to 2:1, more particularly in the range from 1:3 to 1:1.

13. A composition as claimed in claim 1, further comprising a photoinitiator, a radical initiator or an initiator of cationic curing.

14. (canceled)

15. A method for producing an abhesive release layer, wherein a composition as claimed in claim 1 is applied to a substrate and subjected to curing.

16. A release agent obtained by curing a composition as claimed in claim 1.

17. A release film coated with a release agent as claimed in claim 16.
